(19) United States
(12) Patent Application Publication
(10) Pub. No.: US 2024/0316765 A1
(43) Pub. Date: Sep. 26, 2024

(54) ROBOT CONTROL DEVICE AND ROBOT CONTROL METHOD

(71) Applicant: Sony Group Corporation, Tokyo (JP)

(72) Inventors: Yasuhiro MATSUDA, Tokyo (JP); Ryo TERASAWA, Tokyo (JP); Kirill VANHEERDEN, Tokyo (JP)

(73) Assignee: Sony Group Corporation, Tokyo (JP)

(21) Appl. No.: 18/575,338

(22) PCT Filed: Feb. 9, 2022
(86) PCT No.: PCT/JP2022/005212

§ 371 Date: Dec. 29, 2023

(30) Foreign Application Priority Data
Jul. 5, 2021 (JP) 2021-111776

(51) Int. Cl. B25J 9/16; B25J 13/08; B25J 15/00

(52) U.S. Cl. CPC B25J 9/1661; B25J 9/1612; B25J 13/084; B25J 15/0004

(57) ABSTRACT

A robot control device of the present disclosure includes an external force estimation section that obtains torque sensor information and tactile sensor information respectively from a torque sensor and a tactile sensor that are provided on a control target part of a robot, and separates an intended external force by a task given to the robot from an external force acting on the control target part on the basis of the obtained torque sensor information and the obtained tactile sensor information and estimates an unintended external force.

### TECHNICAL FIELD

The present disclosure relates to a robot control device and a robot control method.

### BACKGROUND ART

A robot has a hand that is often involved in an operation on an object; therefore, the hand is likely to collide with an object to be subjected to the operation or an environment. In a case of hand control with high rigidity, while position accuracy is high, safety when contacting a surrounding environment or an object decreases. In contrast, in hand control with flexibility, while safety is high, position accuracy decreases, which may lead to task failure. PTL 1 proposes a technology for implementing highly accurate grasping and flexible grasping with the same mechanism by including two members that are different in rigidity in a finger part of a hand.

### CITATION LIST

### Patent Literature

PTL 1: Japanese Unexamined Patent Application Publication No. 2009-101424

### SUMMARY OF THE INVENTION

It is conceivable that both higher accuracy and high safety are achieved not by a mechanical structure on robot side, but, for example, by adaptively changing hand control in accordance with an external force acting on a hand. In this case, it is desirable to perform external force estimation with high accuracy.

It is desirable to provide a robot control device and a robot control method each of which makes it possible to perform external force estimation with high accuracy.

A robot control device according to an embodiment of the present disclosure includes an external force estimation section that obtains torque sensor information and tactile sensor information respectively from a torque sensor and a tactile sensor that are provided on a control target part of a robot, and separates an intended external force by a task given to the robot from an external force acting on the control target part, on the basis of the obtained torque sensor information and the obtained tactile sensor information and estimates an unintended external force.

A robot control method according to an embodiment of the present disclosure includes: obtaining torque sensor information and tactile sensor information respectively from a torque sensor and a tactile sensor that are provided on a control target part of a robot; and separating an intended external force by a task given to the robot from an external force acting on the control target part, on the basis of the obtained torque sensor information and the obtained tactile sensor information and estimating an unintended external force.

In the robot control device or the robot control method according to the embodiment of the present disclosure, the torque sensor information and the tactile sensor information are respectively obtained from the torque sensor and the tactile sensor that are provided on the control target part of the robot, and the intended external force by the task given to the robot is separated from the external force acting on the control target part, on the basis of the obtained torque sensor information and the obtained tactile sensor information to estimate the unintended external force.

### BRIEF DESCRIPTION OF DRAWINGS

FIG. 1 is an explanatory diagram illustrating an example of an environment where an object to be subjected to a hand operation by a robot according to a comparative example is placed.

FIG. 2 is an explanatory diagram illustrating an example of interference with a surrounding object involved in the hand operation by the robot according to the comparative example.

FIG. 3 is an explanatory diagram illustrating an example of a decrease in position accuracy in a case where hand control with flexibility is performed in the robot according to the comparative example.

FIG. 4 is an appearance diagram schematically illustrating an example of a robot to be controlled by a robot control device and a robot control method according to a first embodiment of the present disclosure.

FIG. 5 is a configuration diagram schematically illustrating an example of a hand of the robot to be controlled by the robot control device and the robot control method according to the first embodiment.

FIG. 6 is a block diagram illustrating a configuration example of an external force estimation section in the robot control device according to the first embodiment.

FIG. 7 is an explanatory diagram illustrating specific tasks and examples of external force estimation corresponding to the tasks.

FIG. 8 is a block diagram illustrating an entire configuration example of the robot control device according to the first embodiment.

FIG. 9 is an explanatory diagram illustrating an example of torque modulation in an external force adaptive controller in the robot control device according to the first embodiment.

FIG. 10 is an explanatory diagram illustrating specific tasks and examples of torque modulation and hand control corresponding to the tasks.

FIG. 11 is a flowchart illustrating an example of a control operation by the robot control device according to the first embodiment.

FIG. 12 is an explanatory diagram illustrating an overview of hand control by a robot control device and a robot control method according to a second embodiment.

FIG. 13 is a block diagram illustrating an entire configuration example of the robot control device according to the second embodiment.

FIG. 14 is a block diagram illustrating an entire configuration example of a robot control device according to a third embodiment.

FIG. 15 is a block diagram illustrating an entire configuration example of a robot control device according to a fourth embodiment.

FIG. 16 is a flowchart illustrating an example of a control operation by the robot control device according to the fourth embodiment.

### MODES FOR CARRYING OUT THE INVENTION

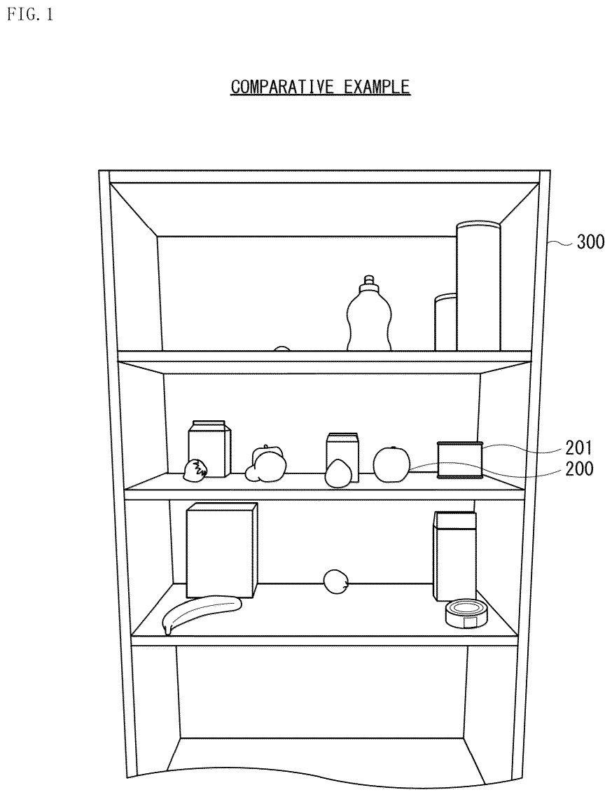

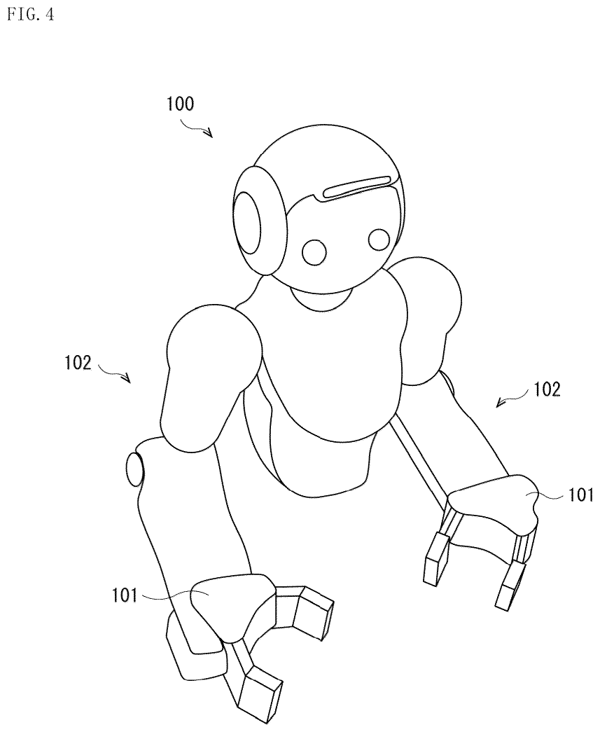

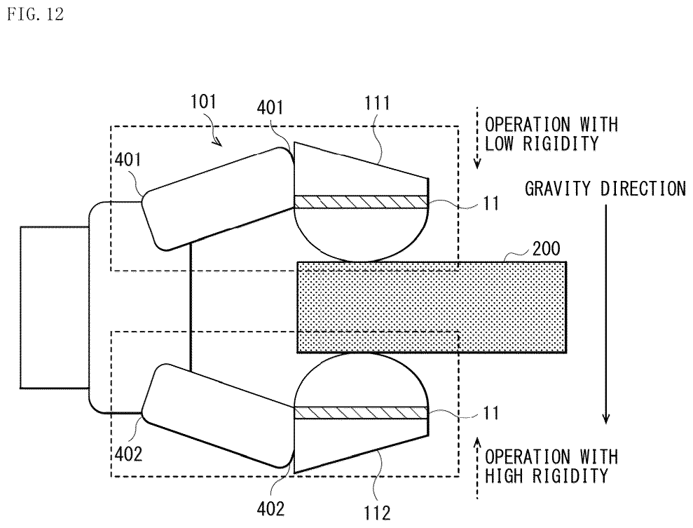

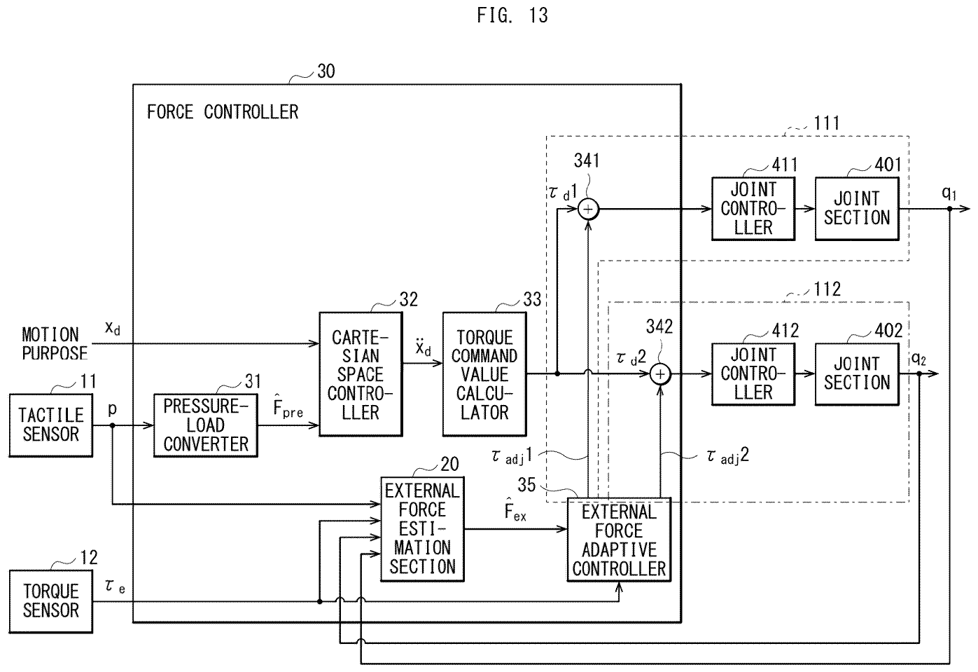

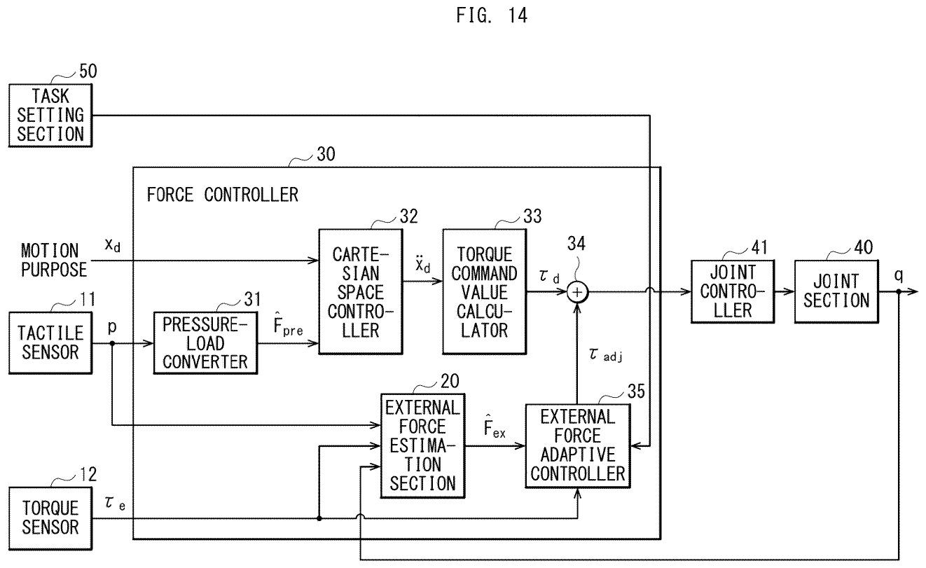

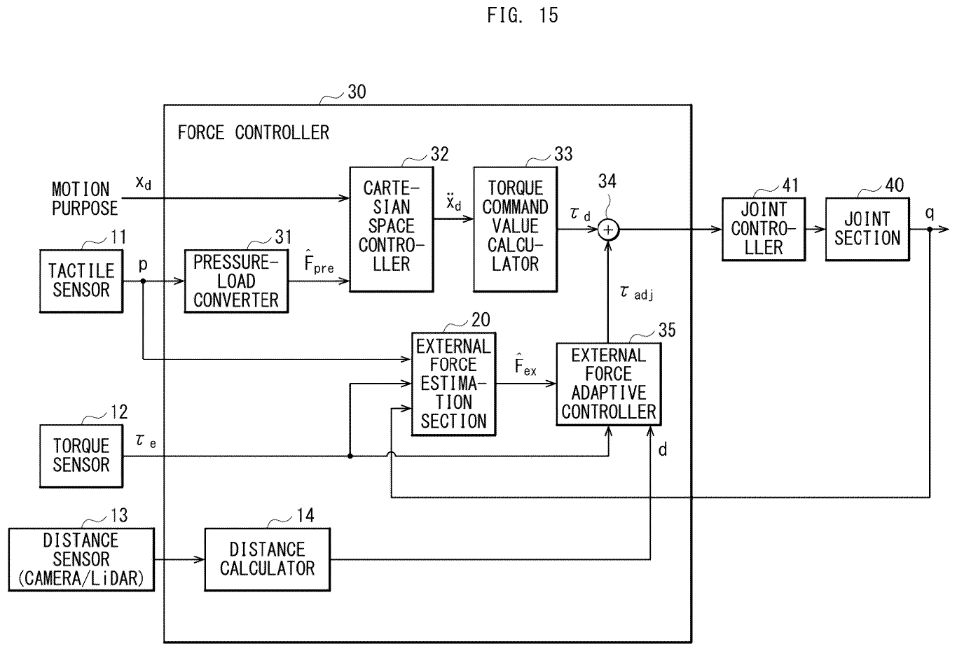

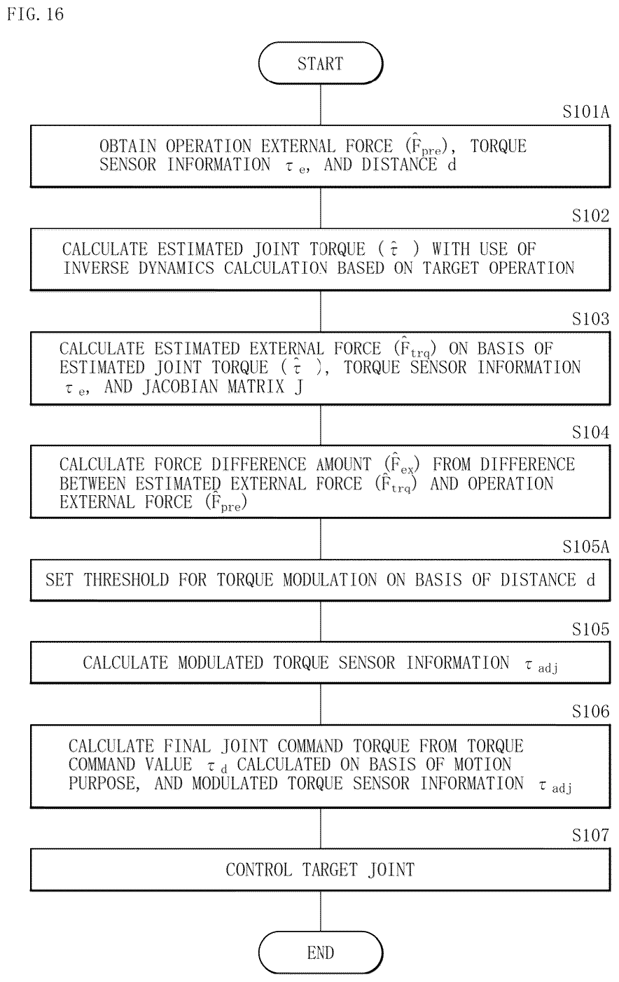

Some embodiments of the present disclosure are described below in detail with reference to the drawings. It is to be noted that description is given in the following order.
0. Comparative Example (FIGS. 1 to 3)
1. First Embodiment (FIGS. 4 to 11)
1.1 Configuration of External Force Estimation Section and Calculation Example of External Force Estimation
1.2 Configuration of Force Controller and Example of Hand Control
1.3 Operation
1.4 Effects
1.5 Modification Example
2. Second Embodiment (An example in which individual hand control for each finger part is performed) (FIGS. 12 and 13)
3. Third Embodiment (An example in which hand control corresponding to a task is performed) (FIG. 14)
4. Fourth Embodiment (An example in which hand control corresponding to a surrounding environment is performed) (FIGS. 15 and 16)
5. Other Embodiments

### 0. Comparative Example

### (Overview and Issues of Robot Control Device and Robot Control Method According to Comparative Example)

FIG. 1 illustrates an example of an environment where an object to be subjected to a hand operation by a robot according to a comparative example is placed.

A robot has a hand that is often involved in an operation on an object; therefore, the hand is likely to collide with an object to be subjected to the operation or an environment. In particular, as illustrated in FIG. 1, this is noticeable in an untidy environment where many surrounding objects 201 are present in addition to an object 200 to be subjected to an operation, and in a case where the object 200 to be subjected to the operation is disposed close to an environment such as a shelf 300.

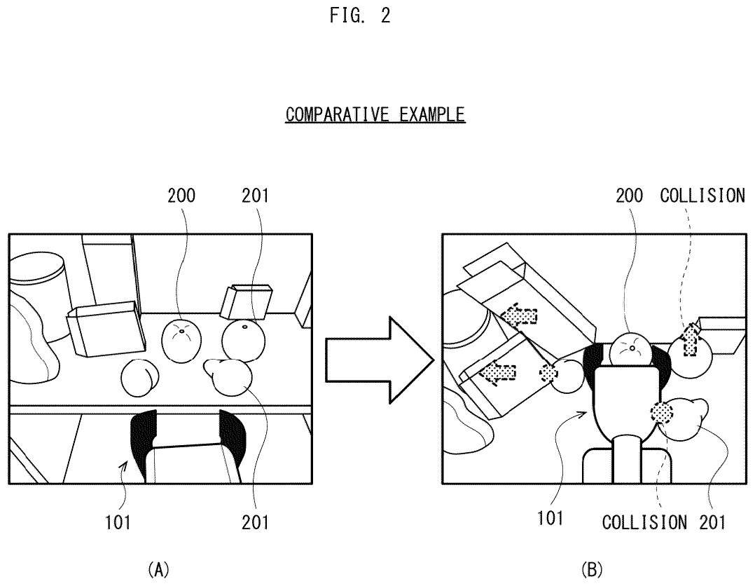

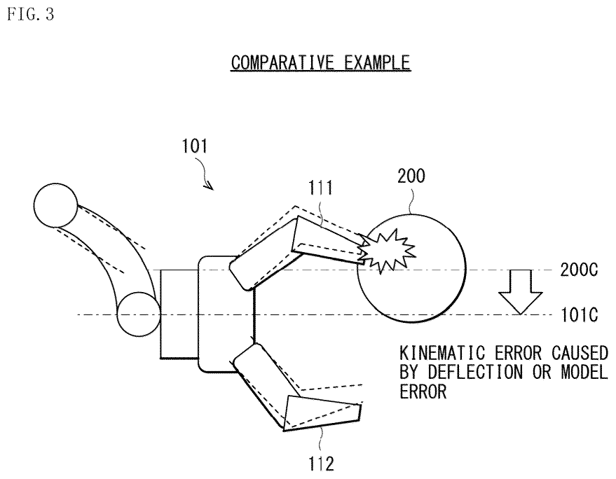

FIG. 2 illustrates an example of interference with the surrounding object 201 involved in the hand operation by the robot according to the comparative example. In FIG. 2, (A) illustrates a state before the object 200 to be subjected to the operation by a hand 101 is grasped, and (B) illustrates a state immediately before the object 200 to be subjected to the operation is grasped by the hand 101. FIG. 3 illustrates an example of a decrease in position accuracy in a case where hand control with flexibility is performed in the robot according to the comparative example. As illustrated in FIG. 3, the hand 101 includes a first finger section 111 and a second finger section 112 as grasping sections.

In a case of hand control with high rigidity, as illustrated in (B) of FIG. 2, while position accuracy is high, safety is decreased by contacting (colliding with) a surrounding environment or the surrounding object 201. In contrast, in a case of hand control with flexibility, while safety is high, a sensitive reaction to disturbance, or noise, a model error, or the like occurs to decrease accuracy of a position and an orientation of a hand tip, which may lead to task failure. For example, as illustrated in FIG. 3, in a case where the object 200 is to be grasped so as to align an object center 200C with a center position 101C of the hand 101, there is a possibility that a task fails due to collision of, for example, the first finger section 111 with the object 200 by a kinematic error caused by deflection of the hand 101, an model error, or the like.

In general, it is difficult to implement a hand operation with high rigidity and high accuracy and a hand operation with flexibility and high safety by the same control law. Accordingly, switching of a control law in accordance with a task or an environment is conceivable; however, the following respective issues arise in terms of external force sensing and force control. As an issue in terms of external force sensing, it is difficult to separate an external force caused by intended contact that is necessary for task execution and an external force generated by unintentionally colliding with an environment or an obstacle. In addition, as an issue in terms of force control, there is a possibility that a decrease in stability such as vibration or operation discontinuity occurs in switching an operation.

Accordingly, in terms of external force sensing, it is desirable to develop a technology for making it possible to perform external force estimation with high accuracy. In addition, in terms of force control, it is desirable to develop a technology for making it possible to perform adaptive force control corresponding to an external force. Thus, it is desirable to develop a technology for achieving both higher accuracy and high safety for control of a hand or the like of a robot.

### 1. First Embodiment

### [1.1 Configuration of External Force Estimation Section and Calculation Example of External Force Estimation]

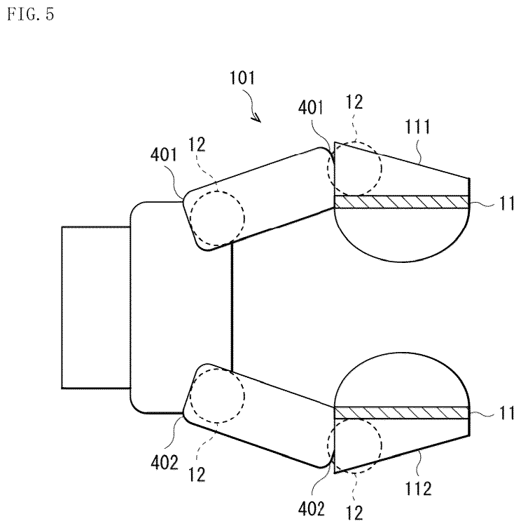

FIG. 4 schematically illustrates an example of a robot 100 to be controlled by a robot control device and a robot control method according to a first embodiment of the present disclosure. FIG. 5 schematically illustrates an example of the hand 101 of the robot 100.

The robot control device and the robot control method according to the first embodiment are suitable, for example, for the robot 100 having an arm 102, as illustrated in FIG. 4. The hand 101 as a control target part is provided on a tip of the arm 102. Note that it is possible to adopt a part other than the hand 101 as a control target part by the robot control device and the robot control method according to the first embodiment. For example, it is possible to adopt an unillustrated foot section as a control target part.

The band 101 is able to grasp the object 200 (see FIG. 1) to be subjected to an operation. The hand 101 includes a grasping section that grasps the object 200 to be subjected to the operation, and a joint section linked with the grasping section. In a configuration example in FIG. 5, an example is illustrated in which two finger sections (the first finger section 111 and the second finger section 112) are included as grasping sections. The first finger section 111 is provided with a plurality of joint sections 401. The second finger section 112 is provided with a plurality of joint sections 402. A tip section of each of the first finger section 111 and the second finger section 112 is provided with a tactile sensor 11. Each of the plurality of joint sections 401 and the plurality of joint sections 402 is provided with a torque sensor 12.

It is to be noted that a configuration including three or more finger sections as grasping sections may be adopted. In addition, each finger section may include only one joint section, or three or more joint sections.

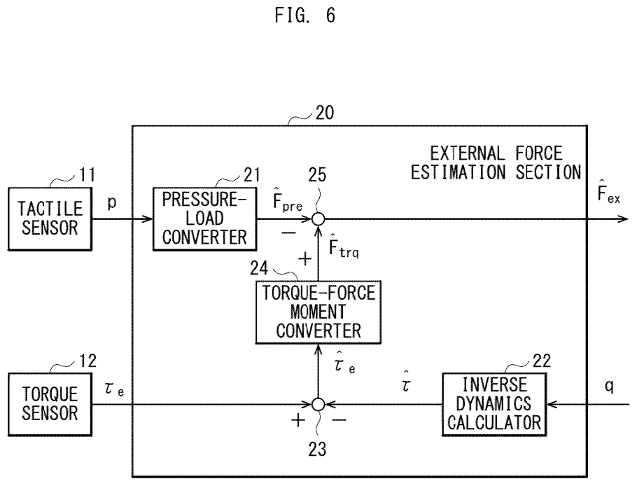

FIG. 6 illustrates a configuration example of an external force estimation section in the robot control device according to the first embodiment.

It is to be noted that in the following text, “(\hat{ })” indicates that a hat symbol (\hat{ }) is put on the top of a letter on the left of the hat symbol. For example, “F(\hat{ })” indicates that a hat symbol is put on the top of the letter “F”. Likewise, “(⋅) or (⋅ ⋅)” indicates that a dot symbol (⋅ ⋅) (a differential symbol) is put on the top of a letter on the left of the dot symbol. For example, “q(⋅ ⋅)” indicates that a dot symbol (⋅ ⋅) is put on the top of the letter “q”.

The robot control device according to the first embodiment includes an external force estimation section 20. The external force estimation section 20 obtains torque sensor information τₑ and tactile sensor information p respectively from the torque sensor 12 and the tactile sensor 11 provided on the hand 101 as a control target part of the robot 100. The external force estimation section 20 separates an intended external force by a task given to the robot 100 from an external force acting on the control target part, on the basis of the obtained torque sensor information τₑ and the tactile sensor information p and estimates an unintended external force.

The external force estimation section 20 includes a pressure-load converter 21, an inverse dynamics calculator 22, a subtracter 23, a torque-force moment converter 24, and a subtracter 25.

The external force estimation section 20 subtracts a second external force (an external force F(\hat{ })ₚᵣₑ) calculated on the basis of the tactile sensor information p from a first external force (an external force F(\hat{ })_{trq}) calculated on the basis of the torque sensor information τₑ to thereby estimate an unintended external force (an estimated external force F(\hat{ })ₑₓ).

The external force estimation section 20 calculates the first external force (the external force F(\hat{ })_{trq}) on the basis of the torque sensor information τₑ and an estimated torque (an estimated joint torque, a dynamics component τ(\hat{ })) calculated with use of inverse dynamics calculation based on a target operation of the control target part.

Hereinafter, a more specific description is given of a calculation example of external force estimation by the external force estimation section 20 in a case where the control target part is the hand 101.

An operation external force (the external force F(\hat{ })ₚᵣₑ) acts on the tactile sensor 11 through the object 200 grasped by the hand 101. The pressure-load converter 21 converts pressure distribution information (the tactile sensor information p) from the tactile sensor 11 into, for example, a six-dimensional force-moment information (the external force F(\hat{ })ₚᵣₑ). Meanwhile, a joint torque (the torque sensor information τₑ) detected by the torque sensor 12 includes a force (a torque) generated from dynamics of the robot 100 itself as the dynamics component τ(\hat{ }) in addition to an external force from the object 200 or an environment. It is possible to determine the dynamics component τ(\hat{ }) by inverse dynamics calculation using the following expression (1) by the inverse dynamics calculator 22. In the expression (1), q is a joint angle vector, M is an inertia matrix (an inertia force term), c is a centrifugal force-Coriolis force term, and g is a gravity term.

$$\begin{matrix}[ Math . 1 ] & \\ \hat{τ} = M ( q ) \ddot{q} + c ( q , \dot{q} ) + g ( q ) & ( 1 )\end{matrix}$$

Subtracting the dynamics component τ(\hat{ }) corresponding to a present state and a target operation from the torque sensor information τₑ from the torque sensor 12 by the subtracter 23 makes it possible to eliminate the dynamics component τ(\hat{ }) of the robot 100 itself and extract a component from the object 200 or an environment as torque information τ(\hat{ })ₑ. The extracted torque information τ(\hat{ })ₑ is converted into hand tip information (the external force F(\hat{ })_{trq}) with use of a Jacobian matrix J in the torque-force moment converter 24 to cause ae dimension of the hand tip information (the external force F(\hat{ })_{trq}) to coincide with a dimension of information (the external force F(\hat{ })ₚᵣₑ) obtained from the tactile sensor 11. It is possible to determine the external force F(\hat{ })_{trq} by calculation by the following expression (2) using the Jacobian matrix J.

$$\begin{matrix}[ Math . 2 ] & \\ {\hat{F}}_{trq} = {( {J}^{T} )}^{- 1} {\hat{τ}}_{e} = {( {J}^{T} )}^{- 1} ( {τ}_{e} - \hat{τ} ) = {( {J}^{T} )}^{- 1} ( {τ}_{e} - ( M ( q ) \ddot{q} + c ( q , \dot{q} ) + g ( q ) ) ) & ( 2 )\end{matrix}$$

Finally, comparing the operation external force (the external force F(\hat{ })ₚᵣₑ) through the object 200 with the external force F(\hat{ })_{trq} from the object 200 or an environment makes it possible to separate whether the external force is an intended external force by a task operation or an unexpected and unintended external force (the estimated external force F(\hat{ })ₑₓ) generated by contact with an environment or the like (an expression (3)).

$$\begin{matrix}[ Math . 3 ] & \\ {\hat{F}}_{ex} = {\hat{F}}_{trq} - {\hat{F}}_{pre} & ( 3 )\end{matrix}$$

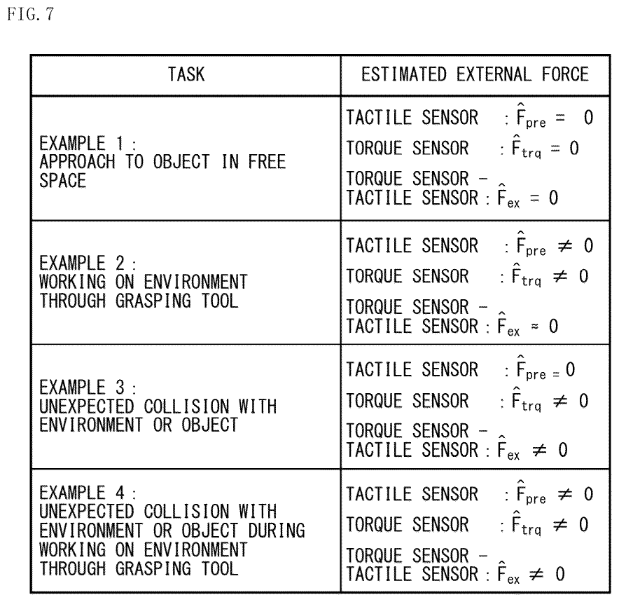

FIG. 7 illustrates specific tasks and examples of external force estimation corresponding to the tasks.

Examples of the specific tasks include approach to the object 200 in free space (Example 1) and working on an environment through a grasping tool (Example 2). In addition, examples of a task that causes generation of an unintended external force include an unexpected collision with an environment or the object 200 (Example 3) and an unexpected collision with an environment or the object 200 during working on the environment through a grasping tool (Example 4).

In a case where an unexpected collision or the like does not occur and an unintended external force is not generated or is small, the estimated external force F(\hat{ })ₑₓ has a value equal to or close to 0. In a case where an unexpected collision or the like occurs and an unintended external force is generated, the estimated external force F(\hat{ })ₑₓ has a value corresponding to the unintended external force.

### [1.2 Configuration of Force Controller and Example of Hand Control]

In the robot control device and the robot control method according to the first embodiment, force control of the control target part of the robot 100 is performed on the basis of the estimated external force F(\hat{ })ₑₓ described above.

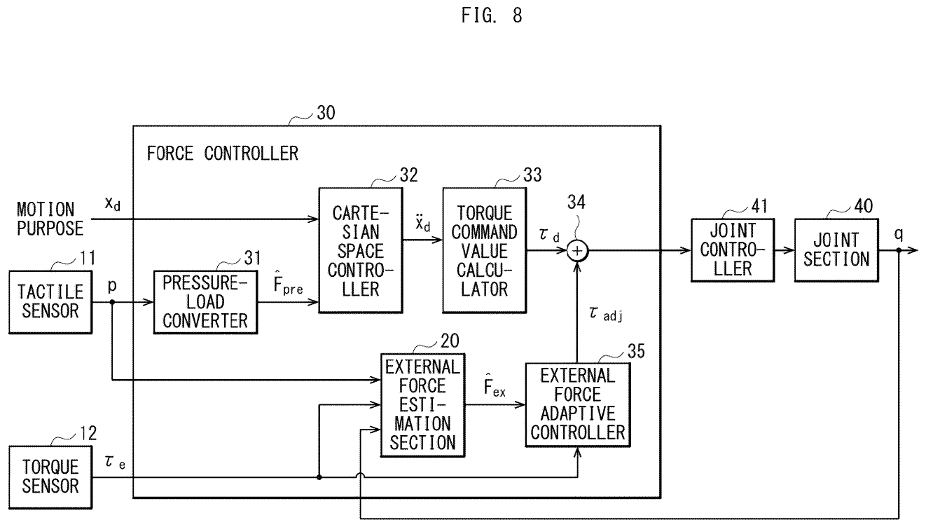

FIG. 8 illustrates an entire configuration example of the robot control device according to the first embodiment including a force controller 30 that performs such force control.

The robot control device according to the first embodiment includes the force controller 30 and a joint controller 41.

The force controller 30 includes a pressure-load converter 31, a Cartesian space controller 32, a torque command value calculator 33, an adder 34, and an external force adaptive controller 35.

The joint section 40 includes, for example, joint sections 401 and 402 in a case of a configuration example of the hand 101 in FIG. 5.

The external force adaptive controller 35 modulates the torque sensor information τₑ on the basis of magnitude of the unintended external force (the estimated external force F(\hat{ })ₑₓ) estimated by the external force estimation section 20. The external force adaptive controller 35 modulates the torque sensor information τₑ so as to increase a torque value indicated by the torque sensor information τₑ with an increase in the unintended external force.

The adder 34 calculates a final torque command value for the control target part on the basis of a torque command value τ_{d} for the control target part that is calculated on the basis of a motion purpose, and modulated torque sensor information τ_{adj} that has been modulated by the external force adaptive controller 35.

The adder 34 corresponds to a specific example of a “torque controller” in the technology of the present disclosure.

Hereinafter, description is given of an example of hand control of the robot 100 as an example of force control by the force controller 30.

In general, a motion target x_{d} of the hand 101 based on a task is indicated by Cartesian space coordinates. The Cartesian space controller 32 includes various controllers, and converts the motion target x_{d} into an acceleration target x(⋅ ⋅)_{d}. As the controllers, for example, a PID (Proportional Integral Differential) controller, an impedance controller, and the like are used. The PID controller achieves a position target at the tip of the hand 101. The impedance controller implements a contact operation with use of force information (the external force F(\hat{ })ₚᵣₑ). In addition to these sensors, a linear controller or a nonlinear controller that further enhances position accuracy of the tip of the hand 101 may be used.

In general, the torque command value calculator 33 calculates the torque command value τ_{d} from the acceleration target x(⋅ ⋅)_{d} with use of dynamics calculation and gives a command to the joint controller 41, which makes it possible to implement the motion target x_{d} of the hand 101. However, in such control only, an external force and an external torque component (torque sensor information τₑ and τ_{adj}) are not considered, which leads to a insensitive state even if an external force acts on the joint section 40 of the hand 101. This makes it difficult to implement an operation other than an operation with high rigidity.

Meanwhile, using the torque sensor 12 makes it possible to always measure, as the torque sensor information τₑ, an external torque acting on the joint section 40 of the hand 101 from an environment or the like. In a force control technique in the first embodiment, the external force adaptive controller 35 modulates an external torque (the torque sensor information τₑ) obtained by the torque sensor 12 into 0 to τₑ on the basis of an external force estimated value (the estimated external force F(\hat{ })ₑₓ). Thereafter, the adder 34 adds the modulated torque sensor information τ_{adj} to the torque command value τ_{d} to thereby implement natural control switching between control with high rigidity and control with flexibility.

Modulation of the torque sensor information τₑ with use of the external force estimated value (the estimated external force F(\hat{ })ₑₓ) by the external force adaptive controller 35 is represented by an expression (4).

$$\begin{matrix}[ Math . 4 ] & \\ {τ}_{adj} = G ( {\hat{F}}_{ex} , {τ}_{e} ) & ( 4 )\end{matrix}$$

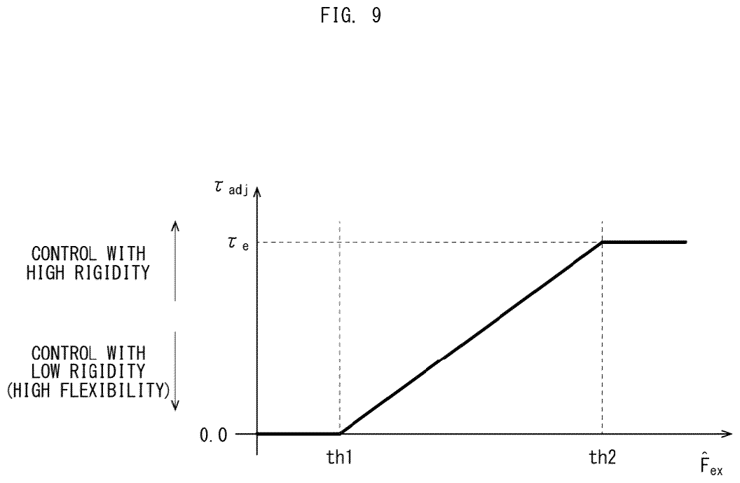

FIG. 9 illustrates an example of torque modulation by the external force adaptive controller 35. For example, in a case of linear modulation as illustrated in FIG. 9, the following modulation results are obtained.
In a case where the external force estimated value (the estimated external force F(\hat{ })ₑₓ) is smaller than a threshold th1, the modulated torque sensor information τ_{adj} is τ_{adj}=0.0.
In a case where the external force estimated value (the estimated external force F(\hat{ })ₑₓ) is larger than a threshold th2, the modulated torque sensor information τ_{adj} is τ_{adj}=τₑ.
While the external force estimated value (the estimated external force F(\hat{ })ₑₓ) falls between thresholds th1 and th2, the modulated torque sensor information τ_{adj} is τ_{adj}=0 to τₑ, for example, by linear conversion as represented by an expression (5).

$$\begin{matrix}[ Math . 5 ] & \\ {τ}_{adj} = \frac{{τ}_{e}}{th 2 - th 1} ( {\hat{F}}_{ex} - {th}_{1} ) & ( 5 )\end{matrix}$$

It is to be noted that torque modulation is not limited to an example of linear modulation described above, and may be modulation using a nonlinear function.

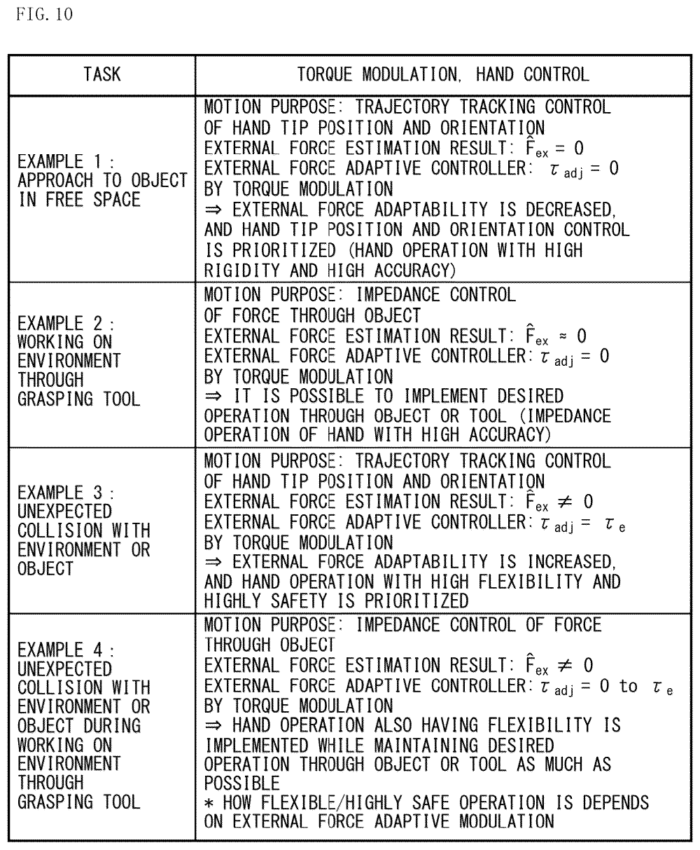

FIG. 10 illustrates specific tasks and examples of torque modulation and hand control corresponding to the tasks.

In a case of approach to the object 200 in free space in Example 1, the motion purpose is trajectory tracking control of a tip position and a tip orientation of the hand 101, and an external force estimation result by the external force estimation section 20 is F(\hat{ })ₑₓ=0. In this case, the external force adaptive controller 35 obtains τ_{adj}=0 by torque modulation. This decreases external force adaptability, and prioritizes position control and orientation control of the tip of the hand 101 (causes a hand operation with high rigidity and high accuracy).

In a case of working on an environment through a grasping tool in Example 2, the motion purpose is impedance control of a force through the object 200, and an external force estimation result by the external force estimation section 20 is F(\hat{ })ₑₓ=0. In this case, the external force adaptive controller 35 obtains τ_{adj}=0 by torque modulation. This makes it possible to implement a desired operation (such as an impedance operation of the hand 101 with high accuracy) through the object 200 or a tool.

In a case of an unexpected collision with an environment or the object 200 in Example 3, the motion purpose is trajectory tracking control of the tip position and the tip orientation of the hand 101, and an external force estimation result by the external force estimation section 20 is F(\hat{ })ₑₓ≠0. In this case, the external force adaptive controller 35 obtains τ_{adj}=τₑ by torque modulation. This increases external force adaptability, and prioritizes a hand operation with high flexibility and highly safety.

In a case of an unexpected collision with an environment or the object 200 during working on the environment through a grasping tool in Example 4, the motion purpose is impedance control of a force through the object 200, and an external force estimation result by the external force estimation section 20 is F(\hat{ })ₑₓ≠0. In this case, the external force adaptive controller 35 obtains τ_{adj}=0 to τₑ by torque modulation. This causes a hand operation also having flexibility to be implemented while maintaining a desired operation through the object 200 or a tool as much as possible. How flexible and highly safe the operation is depends on modulation by the external force adaptive controller 35.

### [1.3 Operation]

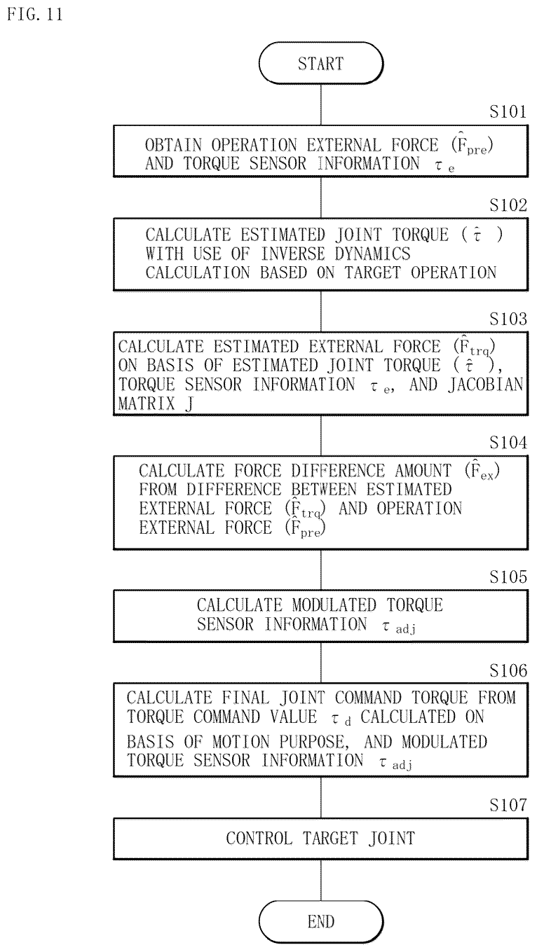

FIG. 11 is a flowchart illustrating an example of a control operation by the robot control device according to the first embodiment.

First, the force controller 30 obtains an operation external force (the external force F(\hat{ })ₚᵣₑ) and the torque sensor information τₑ (step S101). Thereafter, the external force estimation section 20 calculates an estimated joint torque (the dynamics component τ(\hat{ })) with use of inverse dynamics calculation based on a target operation (step S102). Thereafter, the external force estimation section 20 calculates the estimated external force (the external force F(\hat{ })_{trq}) on the basis of the estimated joint torque (the dynamics component τ(\hat{ })), the torque sensor information τₑ, and the Jacobian matrix J (step S103). Thereafter, the external force estimation section 20 calculates a force difference amount (the estimated external force F(\hat{ })ₑₓ) from a difference between the estimated external force (the external force F(\hat{ })_{trq}) and the operation external force (the external force F(\hat{ })ₚᵣₑ) (step S104).

Thereafter, the external force adaptive controller 35 calculates the modulated torque sensor information τ_{adj} (step S105). Thereafter, the adder 34 calculates a final joint command torque from the torque command value τ_{d} from the torque command value calculator 33 calculated on the basis of a motion purpose, and the modulated torque sensor information τ_{adj} (step S106). Thereafter, the joint controller 41 performs control of a target joint (the joint section 40) on the basis of the final joint command torque (step S107).

### [1.4 Effects]

As described above, according to the robot control device and the robot control method according to the first embodiment, the torque sensor information τₑ and the tactile sensor information p are respectively obtained from the torque sensor 12 and the tactile sensor 11 provided on the control target part of the robot 100, and an intended external force by a task given to the robot is separated from an external force acting on the control target part on the basis of the obtained torque sensor information τₑ and the obtained tactile sensor information p to estimate an unintended external force (the estimated external force F(\hat{ })ₑₓ). This makes it possible to perform external force estimation with high accuracy.

According to the robot control device and the robot control method according to the first embodiment, adaptive force control corresponding to the estimated external force F(\hat{ })ₑₓ is performed. This makes it possible to achieve both higher accuracy and high safety for control of the hand 101 or the like of the robot 100. For example, it is possible to perform change between hand control with high rigidity and high accuracy and hand control with high flexibility and high safety under the same control law.

According to the robot control device and the robot control method according to the first embodiment, it is possible to adaptively implement hand control with high rigidity and high accuracy and hand control with high flexibility and high safety in accordance with a task or an environment. It is possible to perform automatic hand control by an estimated external force without specific need for setting by a human. For example, it is possible to automatically perform the following hand control.

For example, in a case where no unexpected external force is present (no unexpected external force on the tactile sensor 11 is present and no unexpected external force on the torque sensor 12 is present) in making an approach to the object 200 in free space, it is possible to prioritize position control and orientation control of the tip of the hand 101. Accordingly, it is possible to implement a hand operation with high rigidity and high accuracy, thereby making it possible to aim for a high task success rate.

In addition, for example, in a case where an external force is present (an external force on the tactile sensor 11 is present and no unexpected external force on the torque sensor 12 is present) in working on an environment through the grasped object 200 or a grasping tool, it is possible to prioritize force (impedance) control of the tip of the hand 101. Accordingly, it is possible to implement an impedance operation of the hand 101 with high accuracy, thereby making it possible to aim for an improvement in a contact task success rate.

In addition, for example, in a case where an external force is present (no external force on the tactile sensor 11 is present and an external force on the torque sensor 12 is present) in unintentionally colliding with an environment or an obstacle, it is possible to prioritize adaptive control of an external force acting on the joint section 40 of the hand 101. Accordingly, it is possible to implement a hand operation with high flexibility and high safety, thereby making it possible to decrease a possibility of breakage of an environment or the object 200.

In addition, in a case where an external force is present (an external force on the tactile sensor 11 is present and an external force on the torque sensor 12 is present) when a finger or the like of the hand 101 unintentionally collides with an environment or an obstacle while working on the environment through the grasped object 200 or a tool, it is possible to also consider adaptive control of an external force acting on the joint section 40 of the hand 101. This makes it possible to also consider a hand operation with high flexibility and high safety while implementing an impedance operation of the hand 101 with high accuracy. How flexible and highly safe the operation is depends on modulation by the external force adaptive controller 35.

It is to be noted that the effects described herein are merely illustrative and non-limiting, and other effects may be included. The same applies to effects of the following other embodiments.

### [1.5 Modification Example]

An example has been described above in which torque modulation by the external force adaptive controller 35 is performed with use of a predetermined function; however, torque modulation may be performed with use of, for example, a modulation parameter by machine learning without using the predetermined function. This makes it possible to obtain a control parameter that is robust and suitable for a hand operation in a learning environment.

### 2. Second Embodiment

Next, description is given of a robot control device and a robot control method according to a second embodiment of the present disclosure. It is to be noted that in the following, components substantially the same as those of the robot control device and the robot control method according to the first embodiment described above are denoted by the same reference numerals, and description thereof is omitted as appropriate.

FIG. 12 illustrates an overview of hand control by the robot control device and the robot control method according to the second embodiment.

For example, individual hand control corresponding to a position of each of the finger sections (the first finger section 111 and the second finger section 112) of the hand 101 as grasping sections may be performed. For example, as illustrated in FIG. 12, in a case where the first finger section 111 and the second finger section 112 are in a different positional relationship with respect to a gravity direction, hand control may be performed so that a finger section on floor surface side (e.g., the second finger section 112) performs an operation with high rigidity and prioritizes accuracy and a finger section (e.g., the first finger section 111) facing the finger section on floor surface side performs an operation of flexibly pressing the object 200 with low rigidity.

In addition, for example, in a case of a configuration in which the hand 101 includes a finger section corresponding to a thumb and another finger section, hand control may be performed so that the finger section corresponding to the thumb performs an operation with high rigidity and the other finger section performs an operation with low rigidity and flexibility.

FIG. 13 illustrates an entire configuration example of the robot control device according to the second embodiment that implements hand control as described above.

In the robot control device according to the second embodiment, the force controller 30 includes a plurality of adders 341 and 342 as the adder 34.

The adders 341 and 342 correspond to specific examples of a “torque controller” in the technology of the present disclosure.

Respective joint angle vectors q1 and q2 from the plurality of joint sections 401 and 402 in the first finger section 111 and the second finger section 112 are inputted to the external force estimation section 20.

The external force adaptive controller 35 performs, on the torque information τₑ in each of the plurality of joint sections 401 and 402, individual modulation corresponding to each of the positions where the plurality of joint sections 401 and 402 is provided, and outputs modulated torque sensor information τ_{adj}1 and modulated torque sensor information τ_{adj}2 to the adders 341 and 342.

The adders 341 and 342 respectively calculate final torque command values for the plurality of joint sections 401 and 402 on the basis of torque command values τ_{d}1 and τ_{d}2 for the plurality of joint sections 401 and 402 calculated on the basis of a motion purpose, and the modulated torque sensor information τ_{adj}1 and the modulated torque sensor information τ_{adj}2 in the plurality of joint sections 401 and 402 that have been individually modulated by the external force adaptive controller 35.

The joint controllers 411 and 412 respectively control the joint sections 401 and 402 on the basis of the final torque command values for the plurality of joint sections 401 and 402.

Other configurations, operations, and effects may be substantially similar to those in the robot control device and the robot control method according to the first embodiment described above.

### 3. Third Embodiment

Next, description is given of a robot control device and a robot control method according to a third embodiment of the present disclosure. It is to be noted that in the following, components substantially the same as those of the robot control device and the robot control method according to the first and second embodiments described above are denoted by the same reference numerals, and description thereof is omitted as appropriate.

FIG. 14 illustrates an entire configuration example of the robot control device according to the third embodiment.

In the robot control device according to the third embodiment, the force controller 30 performs force control corresponding to a task specified by a task setting section 50. The external force adaptive controller 35 modulates the torque sensor information τₑ on the basis of magnitude of an unintended external force (the estimated external force F(\hat{ })ₑₓ) estimated by the external force estimation section 20, and the task specified by the task setting section 50.

According to the robot control device and the robot control method according to the third embodiment, for example, in a task that does not need accuracy such as opening of a door, it is possible to perform hand control prioritizing a hand operation with high safety and flexibility.

In addition, in a task in which position accuracy is important, even in a case where the hand 101 comes into contact with an environment, it is possible to perform hand control prioritizing an operation with high rigidity and high accuracy.

In addition, for example, it is possible to perform hand control so that a priority is reset in accordance with replanning of a task on failure.

Other configurations, operations, and effects may be substantially similar to those in the robot control device and the robot control method according to the first embodiment described above.

### 4. Fourth Embodiment

Next, description is given of a robot control device and a robot control method according to a fourth embodiment of the present disclosure. It is to be noted that in the following, components substantially the same as those of the robot control device and the robot control method according to the first to third embodiments described above are denoted by the same reference numerals, and description thereof is omitted as appropriate.

The external force adaptive controller 35 may modulate the torque sensor information τₑ on the basis of magnitude of an unintended external force estimated by the external force estimation section 20 and environment information about surroundings of the robot 100. The environment information may include distance information with respect to the object 200 around the robot 100.

FIG. 15 illustrates an entire configuration example of the robot control device according to the fourth embodiment that implements hand control using the distance information as described above.

In the robot control device according to the second embodiment, the force controller 30 further includes a distance calculator 14. The distance calculator 14 calculates a distance d between the robot 100 and a surrounding environment or an object on the basis of sensor information from a distance sensor 13. The distance sensor 13 includes, for example, a camera (an image sensor) or a LIDAR (Light Detection And Ranging).

According to the robot control device according to the fourth embodiment, hand control corresponding to a surrounding environment is possible. For example, in a case of an environment in which a human or an object is present around the robot 100, hand control is possible so that an operation with high safety and flexibility is performed.

FIG. 16 is a flowchart illustrating an example of a control operation by the robot control device according to the fourth embodiment. It is to be noted that, in the flowchart in FIG. 16, processing steps other than step S101A and step S105A are similar to those in the flowchart illustrated in FIG. 11.

First, the force controller 30 obtains an operation external force (the external force F(\hat{ })ₚᵣₑ), the torque sensor information τₑ, and the distance d (step S101A). Thereafter, the external force estimation section 20 calculates an estimated joint torque (the dynamics component τ(\hat{ })) with use of inverse dynamics calculation based on a target operation (step S102). Thereafter, the external force estimation section 20 calculates the estimated external force (the external force F(\hat{ })_{trq}) on the basis of the estimated joint torque (the dynamics component τ(\hat{ })), the torque sensor information τₑ, and the Jacobian matrix J (step S103). Thereafter, the external force estimation section 20 calculates a force difference amount (the estimated external force F(\hat{ })ₑₓ) from a difference between the estimated external force (the external force F(\hat{ })_{trq}) and the operation external force (the external force F(\hat{ })ₚᵣₑ) (step S104).

Thereafter, the external force adaptive controller 35 sets a threshold for torque modulation on the basis of the distance d (step S105A). Thereafter, the external force adaptive controller 35 calculates the modulated torque sensor information τ_{adj} (step S105B). Thereafter, the adder 34 calculates a final joint command torque from the torque command value τ_{d} from the torque command value calculator 33 calculated on the basis of a motion purpose, and the modulated torque sensor information τ_{adj} (step S106). Thereafter, the joint controller 41 performs control of a target joint (the joint section 40) on the basis of the final joint command torque (step S107).

Other configurations, operations, and effects may be substantially similar to those in the robot control device and the robot control method according to the first embodiment described above.

### 5. Other Embodiments

The technology according to the present disclosure is not limited to description of the embodiments described above, and may be modified in a variety of ways.

For example, the present technology may have the following configurations. According to the present technology having the following configurations, torque sensor information and tactile sensor information are respectively obtained from a torque sensor and a tactile sensor that are provided on a control target part of a robot, and an intended external force by a task given to the robot is separated from an external force acting on the control target part on the basis of the obtained torque sensor information and the obtained tactile sensor information to estimate an unintended external force.

This makes it possible to perform external force estimation with high accuracy.

(1)

A robot control device including:
an external force estimation section that obtains torque sensor information and tactile sensor information respectively from a torque sensor and a tactile sensor that are provided on a control target part of a robot, and separates an intended external force by a task given to the robot from an external force acting on the control target part on the basis of the obtained torque sensor information and the obtained tactile sensor information and estimates an unintended external force.

(2)

The robot control device according to (1), in which the external force estimation section subtracts a second external force calculated on the basis of the tactile sensor information from a first external force calculated on the basis of the torque sensor information to thereby estimate the unintended external force.

(3)

The robot control device according to (2), in which the external force estimation section calculates the first external force on the basis of the torque sensor information, and an estimated torque calculated with use of inverse dynamics calculation based on a target operation of the control target part.

(4)

The robot control device according to any one of (1) to (3), further including an external force adaptive controller that modulates the torque sensor information on the basis of magnitude of the unintended external force estimated by the external force estimation section.

(5)

The robot control device according to (4), further including a torque controller that calculates a final torque command value for the control target part on the basis of a torque command value for the control target part calculated on the basis of a motion purpose, and the torque sensor information that has been modulated by the external force adaptive controller.

(6)

The robot control device according to (4) or (5), in which the external force adaptive controller modulates the torque sensor information to increase a torque value indicated by the torque sensor information with an increase in the unintended external force.

(7)

The robot control device according to (5), in which
the control target part includes a plurality of joint sections,
the torque sensor is provided on each of the plurality of joint sections,
the external force adaptive controller performs, on the torque sensor information in each of the plurality of joint sections, individual modulation corresponding to each of positions where the plurality of joint sections are provided, and
the torque controller calculates a final torque command value for each of the plurality of joint sections on the basis of a torque command value for each of the plurality of joint sections calculated on the basis of the motion purpose, and the torque sensor information in each of the plurality of joint sections individually that has been modulated by the external force adaptive controller.

(8)

The robot control device according to (4) or (5), in which the external force adaptive controller modulates the torque sensor information on the basis of magnitude of the unintended external force estimated by the external force estimation section, and a specified task.

(9)

The robot control device according to (4), in which the external force adaptive controller modulates the torque sensor information on the basis of magnitude of the unintended external force estimated by the external force estimation section, and environment information about surroundings of the robot.

(10)

The robot control device according to (9), in which the environment information includes distance information with respect to an object around the robot.

(11)

The robot control device according to any one of (1) to (10), in which
the robot includes, as the control target part, a hand that is configured to grasp an object,
the hand includes a grasping section that grasps the object, and a joint section,
the torque sensor is provided on the joint section of the hand, and
the tactile sensor is provided on the grasping section of the hand.

(12)

A robot control method including:
obtaining torque sensor information and tactile sensor information respectively from a torque sensor and a tactile sensor that are provided on a control target part of a robot; and
separating an intended external force by a task given to the robot from an external force acting on the control target part on the basis of the obtained torque sensor information and the obtained tactile sensor information and estimating an unintended external force.

This application claims the priority on the basis of Japanese Patent Application No. 2021-111776 filed on Jul. 5, 2021 with Japan Patent Office, the entire contents of which are incorporated in this application by reference.

It should be understood by those skilled in the art that various modifications, combinations, sub-combinations, and alterations may occur depending on design requirements and other factors insofar as they are within the scope of the appended claims or the equivalents thereof.

1. A robot control device comprising:
an external force estimation section that obtains torque sensor information and tactile sensor information respectively from a torque sensor and a tactile sensor that are provided on a control target part of a robot, and separates an intended external force by a task given to the robot from an external force acting on the control target part on a basis of the obtained torque sensor information and the obtained tactile sensor information and estimates an unintended external force.

2. The robot control device according to claim 1, wherein the external force estimation section subtracts a second external force calculated on a basis of the tactile sensor information from a first external force calculated on a basis of the torque sensor information to thereby estimate the unintended external force.

3. The robot control device according to claim 2, wherein the external force estimation section calculates the first external force on a basis of the torque sensor information, and an estimated torque calculated with use of inverse dynamics calculation based on a target operation of the control target part.

4. The robot control device according to claim 1, further comprising an external force adaptive controller that modulates the torque sensor information on a basis of magnitude of the unintended external force estimated by the external force estimation section.

5. The robot control device according to claim 4, further comprising a torque controller that calculates a final torque command value for the control target part on a basis of a torque command value for the control target part calculated on a basis of a motion purpose, and the torque sensor information that has been modulated by the external force adaptive controller.

6. The robot control device according to claim 4, wherein the external force adaptive controller modulates the torque sensor information to increase a torque value indicated by the torque sensor information with an increase in the unintended external force.

7. The robot control device according to claim 5, wherein
the control target part includes a plurality of joint sections,
the torque sensor is provided on each of the plurality of joint sections,
the external force adaptive controller performs, on the torque sensor information in each of the plurality of joint sections, individual modulation corresponding to each of positions where the plurality of joint sections are provided, and
the torque controller calculates a final torque command value for each of the plurality of joint sections on a basis of a torque command value for each of the plurality of joint sections calculated on a basis of the motion purpose, and the torque sensor information in each of the plurality of joint sections individually that has been modulated by the external force adaptive controller.

8. The robot control device according to claim 4, wherein the external force adaptive controller modulates the torque sensor information on a basis of magnitude of the unintended external force estimated by the external force estimation section, and a specified task.

9. The robot control device according to claim 4, wherein the external force adaptive controller modulates the torque sensor information on a basis of magnitude of the unintended external force estimated by the external force estimation section, and environment information about surroundings of the robot.

10. The robot control device according to claim 9, wherein the environment information includes distance information with respect to an object around the robot.

11. The robot control device according to claim 1, wherein
the robot includes, as the control target part, a hand that is configured to grasp an object,
the hand includes a grasping section that grasps the object, and a joint section,
the torque sensor is provided on the joint section of the hand, and
the tactile sensor is provided on the grasping section of the hand.

12. A robot control method comprising:
obtaining torque sensor information and tactile sensor information respectively from a torque sensor and a tactile sensor that are provided on a control target part of a robot; and
separating an intended external force by a task given to the robot from an external force acting on the control target part on a basis of the obtained torque sensor information and the obtained tactile sensor information and estimating an unintended external force.
